(19) United States
(12) Patent Application Publication
(10) Pub. No.: US 2010/0257021 A1
(43) Pub. Date: Oct. 7, 2010

(54) CHECKING CAPLIMITS

(75) Inventors: Manik GROVER, Delhi (IN); Ambarish NAGARAJAN, Bangalore (IN)

Correspondence Address: Evergreen Valley Law Group, P.C. and Yahoo! Inc., 4 South Second Street, Suite 598, San Jose, CA, 95113, US

(73) Assignee: Yahoo! Inc., Sunnyvale, CA (US)

(21) Appl. No.: 12/418,613

(22) Filed: Apr. 6, 2009

(51) Int. Cl. G06Q 30/00; G06Q 10/00

(52) U.S. Cl. 705/10; 705/14.49

(57) ABSTRACT

Checking CapLimits. An example of a method for checking CapLimits includes receiving a request for updating an account of an advertiser with one or more key phrases. The method also includes obtaining a Cap Limit associated with the account. Further, the method includes identifying number of non-deleted key phrases associated with the account. The method also includes determining whether sum of the number of non-deleted key phrases and number of the one or more key phrases is less than the Cap Limit. The method includes updating the account with the one or more key phrases if the sum is determined to be less than the Cap Limit. Moreover, the method includes receiving at least one key phrase of the one or more key phrases as an input from an electronic device. Furthermore, the method includes providing advertisements associated with the account based on the at least one key phrase.

### BACKGROUND

Advertising is a form of communication that attempts to persuade potential customers to purchase or to consume a particular brand of product or service. Often, Electronic-commerce uses an advertising system consisting of an assortment of advertisements placed by an advertising agency on behalf of a company or other organization. Currently, the advertising system enforces a CapLimit to an account associated with the advertising agency. The CapLimit for a particular type of object of the account is the maximum number of objects of the particular type that the account can accommodate.

In an exemplary search marketing data model, the account objects are divided into three levels with parent-child hierarchy. In order to check the CapLimit of an object at lowest level, status check of objects at all the three levels needs to be performed. The CapLimit checking includes determining whether a sum of number of new objects and number of existing active objects is below the CapLimit. An active object is defined as the object with all parents in active state. However, determining the existing active objects is tedious and time consuming. A large number of data joins and status check needs to be performed at each level as each level has information only about its immediate parent and does not have information about parent of the immediate parent. The situation worsens, when the CapLimit check has to be performed on millions of objects present at the lower level. Thus, performing the CapLimit check becomes unmanageably complex resulting in more processing time, cost, and logical input output operations.

In light of foregoing discussion there is a need for an efficient technique for checking CapLimits.

### SUMMARY

Embodiments of the present disclosure described herein provide an article of manufacture, a computer-implemented method and a system for checking CapLimits.

An example of an article of manufacture includes a machine-readable medium. The machine-readable medium carries instructions operable to cause a programmable processor to perform receiving a request for updating an account of an advertiser with one or more objects and obtaining a CapLimit associated with the account. Further, the machine-readable medium carries instructions operable to cause the programmable processor to perform identifying number of non-deleted objects associated with the account and determining whether sum of the number of non-deleted objects and number of the one or more objects is less than the CapLimit. Moreover, the machine-readable medium carries instructions operable to cause the programmable processor to perform updating the account with the one or more objects if the sum is determined to be less than the CapLimit.

An example of a computer-implemented method for checking CapLimits includes receiving a request for updating an account of an advertiser with one or more objects. Further, the computer-implemented method includes obtaining a CapLimit associated with the account. Furthermore, the computer-implemented method includes identifying number of non-deleted objects associated with the account. In addition the computer-implemented method includes determining whether sum of the number of non-deleted objects and number of the one or more objects is less than the CapLimit. Further, the computer-implemented method includes updating the account with the one or more objects if the sum is determined to be less than the CapLimit. Furthermore, the method includes receiving at least one object of the one or more objects as an input from an electronic device. The computer-implemented method also includes providing advertisements associated with the account based on the at least one object.

An example of a system for checking CapLimits includes an advertiser electronic device. The system includes a communication interface in electronic communication with the advertiser electronic device for receiving a request for updating an account of an advertiser with one or more objects. Further, the system includes a storage unit for storing information associated with the account and a memory for storing instructions. Furthermore, the system includes a processor responsive to the instructions for updating the account with the one or more objects if sum of number of non-deleted objects associated with the account and number of the one or more objects is less than a CapLimit associated with the account.

### BRIEF DESCRIPTION OF THE FIGURES

FIG. 1 is a block diagram of an environment, in accordance with which various embodiments can be implemented;

FIG. 2 is a block diagram of a server, in accordance with one embodiment;

FIG. 3A and FIG. 3B depict a method for updating an account of an advertiser, in accordance with one embodiment;

FIG. 4A is an illustration of an offer model object, in accordance with one embodiment;

FIG. 4B is an illustration of an updated offer model object, in accordance with one embodiment; and

FIG. 4C is an illustration of an updated offer model object, in accordance with another embodiment.

### DETAILED DESCRIPTION OF THE EMBODIMENTS

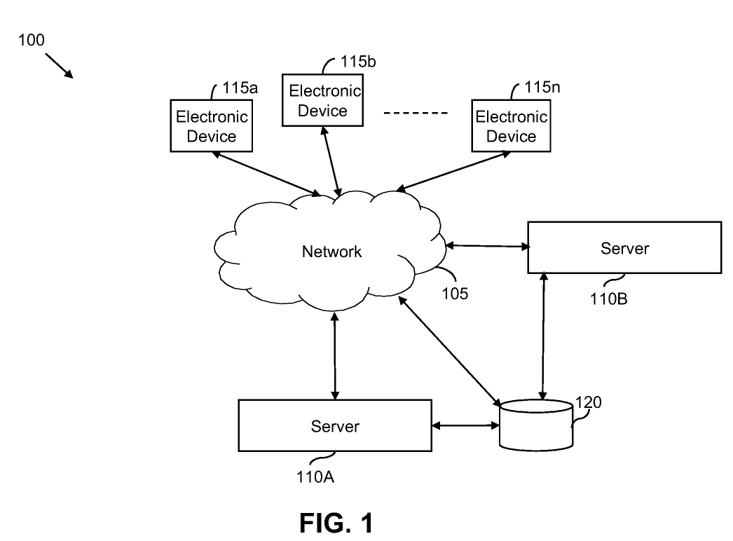

FIG. 1 is a block diagram of an environment 100, in accordance with which various embodiments can be implemented. The environment 100 includes one or more electronic devices, for example, an electronic device 115a, an electronic device 115b and an electronic device 115n connected to each other through a network 105. The electronic devices are also connected to a server 110A through the network 105. The server 110A is connected to a storage device 120. The server 110A can be an application server.

Examples of the electronic devices include, but are not limited to, computers, mobile devices, laptops, palmtops, and personal digital assistants (PDAs). Examples of the network 105 include, but are not limited to, a Local Area Network (LAN), a Wireless Local Area Network (WLAN), a Wide Area Network (WAN), wired network, wireless network, internet and a Small Area Network (SAN).

The server 110A receives a request for updating an account with one or more objects, for example one or more key phrases, from at least one electronic device, for example the electronic device 115a. The electronic device 115a sending the request can be referred to as an advertiser electronic device. The account corresponds to an advertiser. The storage device 120 stores information associated with the account. The information can include an offer model object (OMO) of the account. The OMO is a hierarchical framework including a plurality of levels with parent-child hierarchy. The first level includes objects such as campaigns, second level includes objects such as ad groups, and third level includes objects such as key phrases and advertisements associated with the key phrases. The first level is a parent of both the second level and the third level, and the second level is a parent of the third level. A campaign can have multiple ad groups, and an ad group can have multiple key phrases and multiple advertisements. The campaign can be defined as a particular marketing activity, for example Thanks Giving week marketing. The ad group can be defined as a classification of similar or like advertisements into a set for organization purposes within the campaign. The key phrase can be a single key word or combination of a plurality of key words.

An account can have different CapLimits corresponding to different objects. For example, a CapLimit for campaigns, a CapLimit for ad groups, a CapLimit for advertisements and a CapLimit for key phrases. A CapLimit for a particular type of object can be defined as the maximum number of objects of the particular type that the account or a parent object can accommodate. For example, the CapLimit for the key phrases can be defined as the maximum number of key phrases that the account can accommodate.

It will be appreciated that the present disclosure is explained with help of key phrases as objects and a similar approach can be used for objects at different levels. It will also be appreciated that a similar approach can be used for combination of objects, for example considering a combined CapLimit for all objects together. The CapLimit for the key phrases is hereinafter referred to as the CapLimit associated with the account.

The key phrases can be categorized into various categories, for example a non-deleted key phrase, an inactive key phrase and an active key phrase. An inactive key phrase can be defined as the key phrase having at least one of a parent ad group or a parent campaign as inactive. A non-deleted key phrase can be defined as the key phrase present in the OMO irrespective of whether being active or inactive. An active key phrase can be defined as the non-deleted key phrase having both the parent ad group and the parent campaign as active.

In some embodiments, a fourth level including objects such as uniform resource locators (URLs) can also be present.

The server 110A, in response to the request, updates the account with the one or more key phrases if sum of number of non-deleted key phrases associated with the account and number of the one or more key phrases is less than the CapLimit associated with the account. The key phrases added to the account can be accessed from the storage device 120 directly or through the network 105. The server 110A then receives at least one key phrase as an input from a user electronic device, for example the electronic device 115b. The user electronic device can be defined as an electronic device sending the at least one key phrase as the input to the server 110A. The server 110A then selects and displays an advertisement based on the at least one key phrase on the user electronic device.

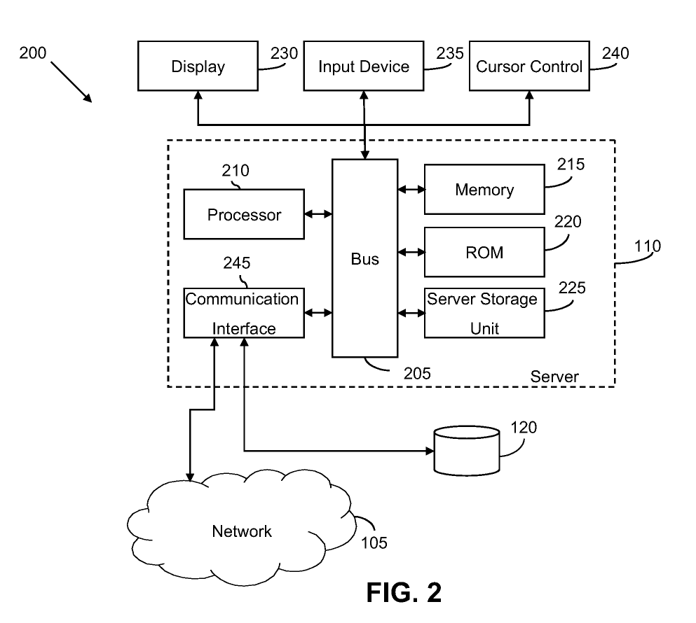

The server 110A includes a plurality of elements for updating the account. The server 110 including the elements is explained in detail in FIG. 2.

The environment 100 can also include a server 110B having access to the storage device 120. The server 110B can be an advertising server. The server 110B can identify advertisement based on the key phrase added to the account and provide it to the users.

FIG. 2 is a block diagram of a server 110A, in accordance with one embodiment. The server 110A includes a bus 205 for communicating information, and a processor 210 coupled with the bus 205 for processing information. The server 110A also includes a memory 215, for example a random access memory (RAM) coupled to the bus 205 for storing instructions to be executed by the processor 210. The memory 215 can be used for storing temporary information required by the processor 210. The server 110A further includes a read only memory (ROM) 220 coupled to bus 205 for storing static information and instructions for the processor 210A. A server storage unit 225, for example a magnetic disk, hard disk or optical disk, can be provided and coupled to bus 205 for storing information and instructions.

The server 110A can be coupled via the bus 205 to a display 230, for example a cathode ray tube (CRT) or liquid crystal display (LCD), for displaying information. An input device 235, including various keys, is coupled to the bus 205 for communicating information and command selections to the processor 210. In some embodiments, cursor control 240, for example a mouse, a trackball, a joystick, or cursor direction keys for command selections to the processor 210 and for controlling cursor movement on the display 230 can also be present.

In one embodiment, the steps of the present disclosure are performed by the server 110A in response to the processor 210 executing instructions included in the memory 215. The instructions can be read into the memory 215 from a machine-readable medium, for example the server storage unit 225. In alternative embodiments, hard-wired circuitry can be used in place of or in combination with software instructions to implement various embodiments.

The term machine-readable medium can be defined as a medium providing data to a machine to enable the machine to perform a specific function. The machine-readable medium can be a storage media. Storage media can include non-volatile media and volatile media. The server storage unit 225 can be a non-volatile media. The memory 215 can be a volatile media. All such media must be tangible to enable the instructions carried by the media to be detected by a physical mechanism that reads the instructions into the machine.

Examples of the machine readable medium includes, but are not limited to, a floppy disk, a flexible disk, hard disk, magnetic tape, a CD-ROM, optical disk, punchcards, papertape, a RAM, a PROM, EPROM, and a FLASH-EPROM.

The machine readable medium can also include online links, download links, and installation links providing the instructions to be executed by the processor 210.

The server 110A also includes a communication interface 245 coupled to the bus 205 for enabling data communication. Examples of the communication interface 245 include, but are not limited to, an integrated services digital network (ISDN) card, a modem, a local area network (LAN) card, an infrared port, a Bluetooth port, a zigbee port, and a wireless port.

In some embodiments, the processor 210, receives a request for updating an account of an advertiser with the one or more objects, for example one or more key phrases, from at least one electronic device. In response, the processor 210 obtains a CapLimit associated with the account from the storage device 120. Further, the processor 210 identifies number of non-deleted key phrases associated with the account. The processor 210 also determines whether sum of the number of non-deleted key phrases and number of the one or more key phrases is less than the CapLimit. In addition, the processor 210 updates the account with the one or more key phrases if the sum is determined to be less than the CapLimit.

The processor 210 then receives at least one key phrase of the one or more key phrases as an input from a user electronic device through the communication interface 245 and displays an advertisement based on the at least one key phrase.

In some embodiments, the processor 210 can include one or more processing units for performing one or more functions of the processor 210. The processing units are hardware circuitry performing specified functions.

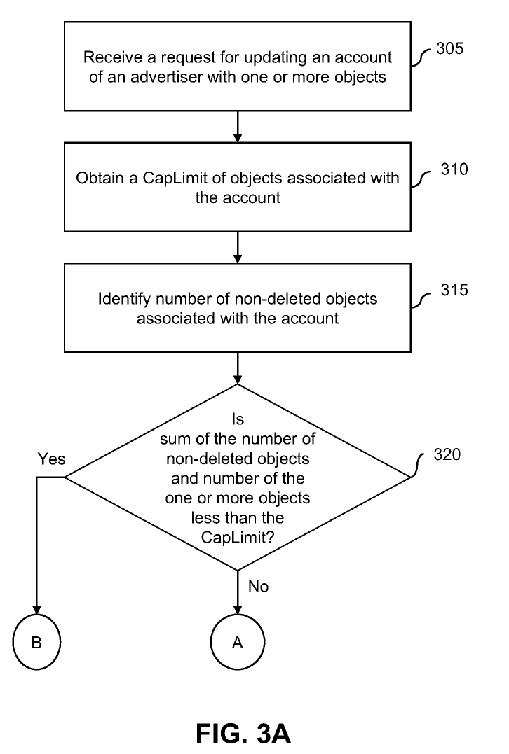

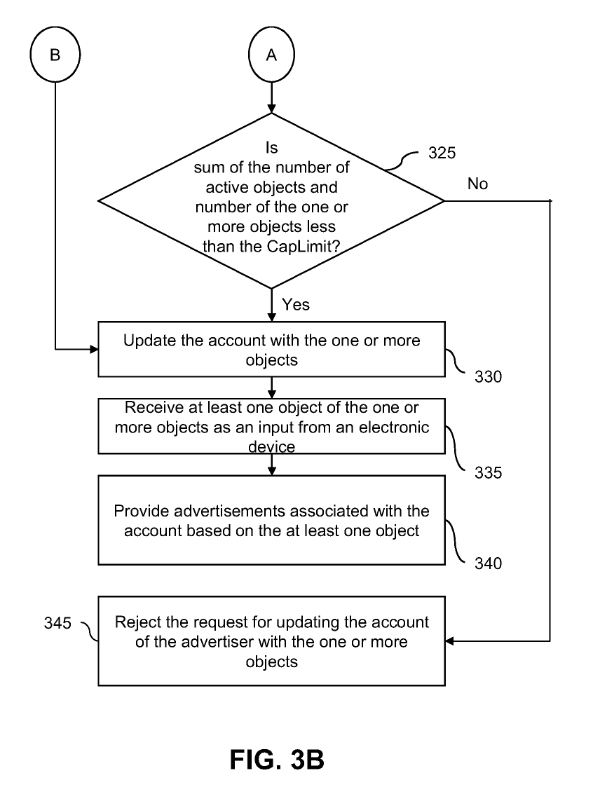

FIG. 3A and FIG. 3B depict a method for updating an account of an advertiser, in accordance with one embodiment.

At step 305, a request for updating the account of the advertiser with one or more objects, for example one or more key phrases, is received. The request can be received by an advertising service provider, for example a Yahoo! Search Marketing (YSM) model, of the account.

At step 310, the CapLimit associated with the account is obtained. The CapLimit can be pre-determined based on type of account and can be fetched from a storage unit. For example, an account of higher importance can have greater CapLimit then an account of lower importance. The importance can be defined based on monetary terms. For example, the advertiser ready to pay more amount can be considered to have higher importance over the advertiser paying less amount. The CapLimit is used for bounding usage of the key phrases by the advertiser in the account. Every account when created can be associated with the CapLimit.

At step 315, number of non-deleted key phrases associated with the account is identified. The number of non-deleted key phrases is identified by counting number of key phrases present at the lower level of the OMO, irrespective of the key phrases being active or inactive.

At step 320, a check is performed to determine whether sum of the number of non-deleted key phrases and number of the one or more key phrases is less than the CapLimit.

If the sum of the number of non-deleted key phrases and number of the one or more key phrases is less than the CapLimit then step 330 is performed, else, step 325 is performed.

At step 325, a check is performed to determine whether sum of the number of active key phrases and the number of the one or more key phrases is less than the CapLimit.

If the sum of the number of active key phrases and the number of the one or more key phrases is less than the CapLimit, then step 330 is performed, else, step 345 is performed.

At step 330, the account is updated with the one or more key phrases. The account is updated by adding the one or more key phrases to the OMO. Further, the inactive objects may be deleted from the updated account.

At step 335, at least one key phrase of the one or more key phrases is received as an input from an electronic device. For example, when a user desires to purchase an IPOD, the user enters a product name “IPOD” which acts as the input.

At step 340, advertisements associated with the account are provided based on the at least one key phrase. It will be appreciated that the advertisements once selected based on the at least one key phrase can be filtered based on various parameters such as bidding factor, add quality, and relevancy to customers.

For example, the advertisements related to the key phrase “IPOD” are displayed to the user based on at least one parameter such as the bidding factor. The user can then purchase the IPOD by performing an online trade.

At step 345, the request for updating the account of the advertiser with the one or more objects is rejected, if it is determined that the sum of the number of the active key phrases and the number of the one or more key phrases exceeds the CapLimit at step 325.

Further, the notification can be sent through short message service (SMS), facsimile, page message, electronic mail service or displayed electronically to the advertiser.

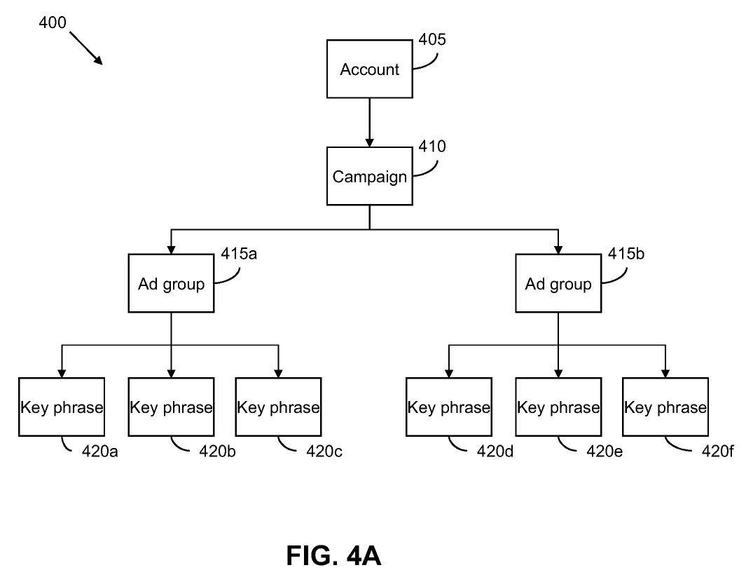

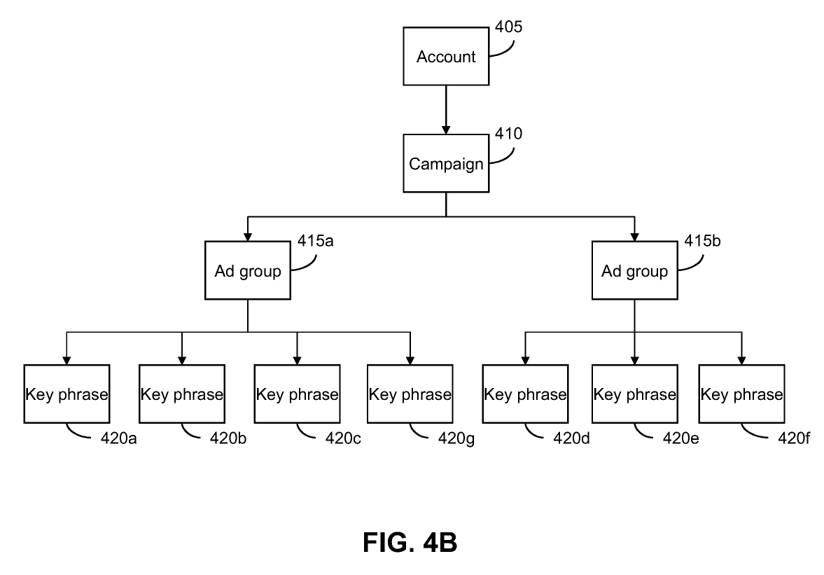

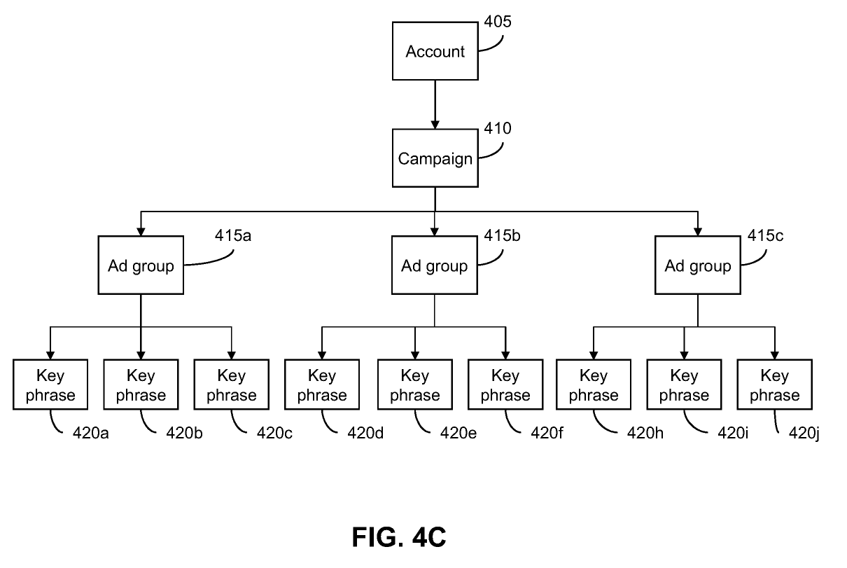

FIG. 4A is an illustration of an offer model object 400, in accordance with one embodiment.

An account 405 includes a campaign 410 at the first level of the OMO. Multiple campaigns can be associated with the account 405. The campaign 410 includes one or more ad groups, for example, an ad group 415a and an ad group 415b, at the second level of the OMO. Each ad group includes one or more key phrases, for example the ad group 415a includes a key phrase 420a, a key phrase 420b and a key phrase 420c, and the ad group 415b includes a key phrase 420d, a key phrase 420e and a key phrase 420f, at the third level of the OMO. In the illustration, the key phrase 420a, the key phrase 420b, and the key phrase 420c are active key phrases. The key phrase 420d, the key phrase 420e, and the key phrase 420f are inactive and non-deleted key phrases. The key phrase Caplimit of the account is predefined as eight and the number of non-deleted key phrases as six.

FIG. 4B is an illustration of an updated offer model object, in accordance with one embodiment.

In the FIG. 4B a request for adding a key phrase 420g to the ad group 415a is received by an advertising system.

The sum of the number of the non-deleted key phrases (6) and the number of key phrases being added (1) is 7 (6+1). Since 7<CapLimit (8), the account is updated with the key phrase 420g.

FIG. 4C is an illustration of an updated offer model object, in accordance with another embodiment.

In the FIG. 4C a request for adding an ad group 415c with one or more key phrases, for example a key phrase 420h, a key phrase 420i, and a key phrase 420j, associated with the ad group 415c is received by an advertising system.

The sum of the number of the non-deleted key phrases (6) and the number of key phrases being added (3) is 9 (6+3). Since 9>CapLimit (8), step 325 is invoked to compute the sum of number of active key phrases (3) and the number of the key phrases being added (3) and get 6 (3+3).

Since 6<CapLimit (8) the account is updated with the ad group 415c and the key phrase 420h, the key phrase 420i, and the key phrase 420j.

Various embodiments provide the method for checking CapLimits using the number of non-deleted key phrases for reducing the processing time, logical input output operations, and large number of data and status checks of the offer model object associated with the account.

While exemplary embodiments of the present disclosure have been disclosed, the present disclosure may be practiced in other ways. Various modifications and enhancements may be made without departing from the scope of the present disclosure. The present disclosure is to be limited only by the claims.

What is claimed is:

1. An article of manufacture comprising:
a machine-readable medium; and
instructions carried by the medium and operable to cause a programmable processor to perform:
receiving a request for updating an account of an advertiser with one or more objects;
obtaining a CapLimit associated with the account;
identifying number of non-deleted objects associated with the account;
determining whether sum of the number of non-deleted objects and number of the one or more objects is less than the CapLimit; and
updating the account with the one or more objects if the sum is determined to be less than the CapLimit.

2. The article of manufacture of claim 1 further comprising instructions operable to cause the programmable processor to perform:
providing advertisements associated with the account based on the one or more objects.

3. The article of manufacture of claim 1 further comprising instructions operable to cause the programmable processor to perform:
determining number of active objects if the sum is determined to be not less than the CapLimit; and
adding the one or more objects if sum of the number of active objects and the number of the one or more objects does not exceed the CapLimit.

4. The article of manufacture of claim 3, wherein determining the number of active objects comprises:
identifying an object of the account as active if the object and all parent objects of the object are active.

5. The article of manufacture of claim 1 further comprising instructions operable to cause the programmable processor to perform:
deleting non-active objects associated with the account.

6. The article of manufacture of claim 1, wherein each object of the one or more objects is a key phrase.

7. The article of manufacture of claim 1, wherein the one or more objects correspond to a pre-defined level in an offer model object associated with the account.

8. The article of manufacture of claim 1, wherein the updating comprises:
adding the one or more objects to the account.

9. A computer-implemented method comprising:
receiving a request for updating an account of an advertiser with one or more objects;
obtaining a CapLimit associated with the account;
identifying number of non-deleted objects associated with the account;
determining whether sum of the number of non-deleted objects and number of the one or more objects is less than the CapLimit;
updating the account with the one or more objects if the sum is determined to be less than the CapLimit;
receiving at least one object of the one or more objects as an input from an electronic device; and
providing advertisements associated with the account based on the at least one object.

10. The method of claim 9 further comprising instructions operable to cause the programmable processor to perform:
determining number of active objects if the sum is determined to be not less than the CapLimit; and
adding the one or more objects if sum of the number of active objects and the number of the one or more objects does not exceed the CapLimit.

11. The method of claim 10, wherein determining the number of active objects comprises:
identifying an object of the account as active if the object and all parent objects of the object are active.

12. The method of claim 9 further comprising:
deleting non-active objects associated with the account.

13. The method of claim 9, wherein each object of the one or more objects is a key phrase.

14. The method of claim 9, wherein the one or more objects correspond to a pre-defined level in an offer model object associated with the account.

15. The method of claim 9, wherein the updating comprises:
adding the one or more objects to the account.

16. A system comprising:
an advertiser electronic device;
a communication interface in electronic communication with the advertiser electronic device for receiving a request for updating an account of an advertiser with one or more objects;
a storage unit for storing information associated with the account;
a memory for storing instructions; and
a processor responsive to the instructions for updating the account with the one or more objects if sum of number of non-deleted objects associated with the account and number of the one or more objects is less than a CapLimit associated with the account.

17. The system of claim 16 further comprising:
a user electronic device for sending at least one object of the one or more objects as an input to the processor through the communication interface, and displaying advertisements associated with the account based on the at least one object.
